(19) United States
(12) Patent Application Publication
(10) Pub. No.: US 2006/0141336 A1
(43) Pub. Date: Jun. 29, 2006

(54) Electrode and electrolyte composite for fuel cell, and method for manufacture thereof

(76) Inventors: Masayuki Takashima, Fukui (JP); Susumu Yonezawa, Fukui (JP); Yuichi Matsumura, Fukui (JP); Hajime Kiyokawa, Fukui (JP); Mamoru Shimakawa, Fukui (JP); Toshihide Tsukatani, Fukui (JP); Koji Fujita, Chiba (JP)

Correspondence Address: FULBRIGHT & JAWORSKI, LLP, 666 FIFTH AVE, NEW YORK, NY, 10103-3198, US

(21) Appl. No.: 10/532,010

(22) PCT Filed: Oct. 21, 2003
(86) PCT No.: PCT/JP03/13449

§ 371 Date: Oct. 19, 2005

(30) Foreign Application Priority Data
Oct. 21, 2002 (JP) 2002-306153

(51) Int. Cl. H01M 4/86; B05D 5/12; H01M 4/88

(52) U.S. Cl. 429/42; 502/101; 427/115

(57) ABSTRACT

An electrode having a thermoplastic resin having gas permiability and a metal (3b) supported in a three-dimensional matrix form; an electrolyte composite having an electrolyte membrane (1) and a pair of electrodes (3), the electrodes (3) comprising a porous thermoplastic resin having gas permiability and a metal (3b) supported in a three-dimensional matrix form; a method of manufacturing an electrode (3) comprising plating a metal coating on surfaces of numerous particles (3a) of a thermoplastic resin, and pressurizing the particles; and a method of manufacturing an electrolyte composite having an electrolyte membrane (1), and a pair of electrodes (3), comprising manufacturing the electrodes (3) by plating a metal coating on surfaces of numerous particles (3a) of a thermoplastic resin and pressurizing the particles, and joining the electrolyte membrane (1) through the catalyst to one surface of each electrode and joining the electrolyte membranes, or joining the electrodes (3) through the catalysts (2) to opposite surfaces of the electrolyte membrane (1).

The present invention relates to an electrode for a fuel cell, a manufacture method therefor, an electrolyte composite for a fuel cell having a solid polymer type electrolyte membrane, and a pair of electrodes joined through catalysts to opposite surfaces of the electrolyte membrane, and a manufacture method therefor.

### BACKGROUND ART

A single cell of a fuel cell includes, for example, an electrolyte membrane consisting of a fluororesin ion-exchange membrane, and a pair of electrodes joined through catalysts to opposite surfaces of the electrolyte membrane. Gas passages are formed outside the pair of electrodes for supplying oxygen and hydrogen gas.

Usually, the electrolyte membrane is very thin and not self-sustainable. The electrodes joined to the opposite surfaces thereof are formed of carbonic paper or the like. Therefore, the electrolyte composite formed of the electrolyte membrane and the pair of electrodes is not self-sustainable, either.

Conventionally, separators formed of carbon which are self-sustainable are arranged outside the two electrodes, and grooves for gas passage are formed in the inner surfaces of the separators. The electrolyte composites are held between the two separators to form a self-sustainable integral unit (see Patent Application “Kokai” No. 2001-325970 (FIGS. 1 and 4), for example).

However, in the prior art noted above, it is essential to assemble the separators formed of carbon in order to render the electrolyte composites self-sustainable. Not only that, grooves for gas passage must be cut in the entire surfaces of the separators formed of carbon. The cutting of the grooves in the separators is a major factor that causes a cost increase of fuel cells.

In addition, since it is necessary to cut grooves in the separators, the separators themselves must have a certain thickness. This increases the thickness of a single cell in a fuel cell, which generally has a thickness of about 5 mm.

The present invention has been made having regard to such disadvantages of the prior art, and its object is to provide an electrode and an electrolyte composite for a fuel cell for achieving a cost reduction and thickness reduction of the fuel cell, and further to provide manufacturing methods for the electrode and electrolyte composite for fuel cells.

### DISCLOSURE OF THE INVENTION

A first characteristic construction of an electrode for a fuel cell according to the present invention lies in comprising a porous thermoplastic resin having gas permiability, and a metal supported in a three-dimensional matrix form on the thermoplastic resin.

With this construction, the electrode for a fuel cell comprises a porous thermoplastic resin having gas permiability, and a metal supported in a three-dimensional matrix form on the thermoplastic resin. The metal in the matrix form secures electrical conduction. The electrode for a fuel cell satisfies required conditions, i.e. has gas permiability and conductivity, and at the same time has self-sustainability provided by the thermoplastic resin.

It is therefore unnecessary to secure self-sustainability by means of separators or the like. For example, it is possible to form grooves for gas passage in the electrode itself by press working. This electrode for a fuel cell may be used to achieve a cost reduction. As shown in embodiments described hereinafter, a single cell which conventionally is about 5 mm in thickness can be reduced to 3.4 to 3.6 mm in thickness, for example, thereby achieving a reduction in thickness of the fuel cell.

A second characteristic construction of the electrode for a fuel cell according to the present invention lies in that the thermoplastic resin is at least one selected from the group consisting of polytetrafluoroethylene (PTFE), polyethylene (PE), polypropylene (PP), ABS resin, polyamide (PA), polysulfone (PSU), AS resin, polystyrene (PS), vinylidene chloride resin (PVDC), vinylidene fluoride resin, PFA resin, polyphenylene ether (PFE), methyl pentene resin and methacrylic resin.

With this construction, the thermoplastic resin is at least one selected from the group consisting of polytetrafluoroethylene (PTFE), polyethylene (PE), polypropylene (PP), ABS resin, polyamide (PA), polysulfone (PSU), AS resin, polystyrene (PS), vinylidene chloride resin (PVDC), vinylidene fluoride resin, PFA resin, polyphenylene ether (PFE), methyl pentene resin and methacrylic resin. Thus, the electrode for a fuel cell advantageously has required conditions to the full extent, and has also required self-sustainability.

A first characteristic construction of an electrolyte composite for a fuel cell according to the present invention lies in an electrolyte composite for a fuel cell having a solid polymer type electrolyte membrane, and a pair of electrodes joined through catalysts to opposite surfaces of the electrolyte membrane, wherein each of said pair of electrodes comprises a porous thermoplastic resin having gas permiability, and a metal supported in a three-dimensional matrix form on the thermoplastic resin.

With this construction, each of a pair of electrodes joined through catalysts to opposite surfaces of a solid polymer type electrolyte membrane comprises a porous thermoplastic resin having gas permiability, and a metal supported in a three-dimensional matrix form on the thermoplastic resin. The metal in the matrix form secures electrical conduction. The electrolyte composite for a fuel cell satisfies required conditions, and itself has self-sustainability provided by the thermoplastic resin.

It is therefore unnecessary to secure self-sustainability by means of separators or the like. For example, it is possible to form grooves for gas passage in the electrode itself by press working. This electrolyte composite for a fuel cell may be used to achieve a cost reduction.

A first characteristic means of a method of manufacturing an electrode for a fuel cell according to the present invention lies in plating a metal coating on surfaces of numerous particles of a thermoplastic resin, and pressurizing and pressure-welding into a plate form the numerous particles having the metal coating formed thereon.

With this means, a metal coating is formed by plating on surfaces of numerous particles of a thermoplastic resin, and the numerous particles having the metal coating formed thereon are pressurized and pressure-welded into a plate form. Thus, the electrode, while having the outstanding effects noted hereinbefore, may be manufactured easily through relatively simple processes such as a plating process and a pressure-welding process. This enables a further cost reduction of the fuel cell.

A second characteristic means of the method of manufacturing the electrode for a fuel cell according to the present invention lies in that said particles are 0.1 μm to 1,000 μm in diameter.

With this means, by using the particles of a thermoplastic resin 0.1 μm to 1,000 μm in diameter in manufacturing the electrode for a fuel cell, both gas permiability and conductivity required for the electrode are assured.

A third characteristic means of the method of manufacturing the electrode for a fuel cell according to the present invention lies in that, in the method of manufacturing the electrode for a fuel cell having the first or second characteristic means noted above, said metal coating is one selected from the group consisting of Ni film, Ni alloy film, Ni compound film, Cu film, Cu alloy film, Cu compound film, Au film, Pt film, Pt alloy film, Pd film, Rh film and Ru film.

With this means, when manufacturing the electrode for a fuel cell, the metal coating formed on the surfaces of the particles of a thermoplastic resin is one selected from the group consisting of Ni film, Ni alloy film, Ni compound film, Cu film, Cu alloy film, Cu compound film, Au film, Pt film, Pt alloy film, Pd film, Rh film and Ru film. Thus, the electrode advantageously has the required conductivity.

A fourth characteristic means of the method of manufacturing the electrode for a fuel cell according to the present invention lies in that, in the method of manufacturing the electrode for a fuel cell having the first or second characteristic means noted above, said metal coating is a film selected from the group consisting of Ni—P, Ni—B, Ni—Cu—P, Ni—Co—P and Ni—Cu—B.

With this means, when manufacturing the electrode for a fuel cell, the metal coating formed on the surfaces of the particles of a thermoplastic resin is a film selected from the group consisting of Ni—P, Ni—B, Ni—Cu—P, Ni—Co—P and Ni—Cu—B. In this case also, the electrode advantageously has the required conductivity.

A fifth characteristic means of the method of manufacturing the electrode for a fuel cell according to the present invention lies in that, in the method of manufacturing the electrode for a fuel cell having the first or second characteristic means noted above, when forming said metal coating, fine grains other than metal are contained in said metal coating, said fine grains being at least one selected from the group consisting of polytetrafluoroethylene (PTFE), polyethylene (PE), polypropylene (PP), ABS resin, polyamide (PA), polysulfone (PSU), AS resin, polystyrene (PS), vinylidene chloride resin (PVDC), vinylidene fluoride resin, PFA resin, polyphenylene ether (PFE), methyl pentene resin, methacrylic resin, carbon (C), catalyst support grains and thermosetting resin.

With this means, when manufacturing the electrode for a fuel cell, and when forming the metal coating on the surfaces of the particles of a thermoplastic resin fine grains other than metal are contained in said metal coating. The fine grains are at least one selected from the group consisting of polytetrafluoroethylene (PTFE), polyethylene (PE), polypropylene (PP), ABS resin, polyamide (PA), polysulfone (PSU), AS resin, polystyrene (PS), vinylidene chloride resin (PVDC), vinylidene fluoride resin, PFA resin, polyphenylene ether (PFE), methyl pentene resin, methacrylic resin, carbon (C), catalyst support grains and thermosetting resin. Thus, the electrode has the required conductivity. Where the metal coating includes PTFE, the interposition of the PTFE allows the electrode and electrolyte membrane to join with each other effectively. Where the catalyst support grains are included, the electrode supports the catalyst reliably.

A first characteristic means of a method of manufacturing an electrolyte composite for a fuel cell according to the present invention lies in a method of manufacturing an electrolyte composite for a fuel cell having a solid polymer type electrolyte membrane, and a pair of electrodes joined through catalysts to opposite surfaces of the electrolyte membrane, the method comprising manufacturing said pair of electrodes by plating a metal coating on surfaces of numerous particles of a thermoplastic resin, and pressurizing and pressure-welding into a plate form the numerous particles having the metal coating formed thereon; and joining said electrolyte membrane through said catalyst to one surface of each of the pair of electrodes, and joining said electrolyte membranes of the two electrodes.

With this means, when manufacturing a pair of electrodes joined through catalysts to opposite surfaces of a solid polymer type electrolyte membrane, a metal coating is plated on surfaces of numerous particles of a thermoplastic resin, and the numerous particles having the metal coating formed thereon are pressurized and pressure-welded into a plate form. Thus, the electrodes may be manufactured easily through relatively simple processes such as a plating process and a pressure-welding process. Further, when manufacturing the electrolyte composite for a fuel cell, the electrolyte membrane is joined through the catalyst to one surface of each of the pair of electrodes, and the electrolyte membranes of the two electrodes are joined together. Thus, the electrolyte composite may be manufactured simply and easily.

A second characteristic means of a method of manufacturing an electrolyte composite for a fuel cell according to the present invention lies in a method of manufacturing an electrolyte composite for a fuel cell having a solid polymer type electrolyte membrane, and a pair of electrodes joined through catalysts to opposite surfaces of the electrolyte membrane, the method comprising manufacturing said pair of electrodes by plating a metal coating on surfaces of numerous particles of a thermoplastic resin, and pressurizing and pressure-welding into a plate form the numerous particles having the metal coating formed thereon; and joining the pair of electrodes through said catalysts to the opposite surfaces of said electrolyte membrane.

With this means, when manufacturing a pair of electrodes joined through catalysts to opposite surfaces of a solid polymer type electrolyte membrane, a metal coating is plated on surfaces of numerous particles of a thermoplastic resin, and the numerous particles having the metal coating formed thereon are pressurized and pressure-welded into a plate form. Thus, the electrodes may be manufactured easily through relatively simple processes such as a plating process and a pressure-welding process. Further, when manufacturing the electrolyte composite for a fuel cell, the respective electrodes are joined through the catalysts to the opposite surfaces of the electrolyte membrane. Thus, the electrolyte composite may be manufactured simply and easily.

### BRIEF DESCRIPTION OF THE DRAWINGS

FIG. 1 is an explanatory view showing a process of manufacturing an electrode and an electrolyte composite for a fuel cell in First Example;

FIG. 2 is a microscopically enlarged schematic view of portion A in FIGS. 1 and 4;

FIG. 3 is an explanatory view showing a single cell in a fuel cell in First Example;

FIG. 4 is an explanatory view showing a process of manufacturing an electrode and an electrolyte composite for a fuel cell in Second Example;

FIG. 5 is an explanatory view showing a single cell in a fuel cell in Second Example; and

FIG. 6 is an explanatory view showing a process of manufacturing an electrode and an electrolyte composite for a fuel cell in another embodiment.

### BEST MODE FOR CARRYING OUT THE INVENTION

Embodiments of the present invention relating to electrodes for fuel cells, electrolyte composites for fuel cells, and manufacturing methods therefor, will be described with reference to the drawings.

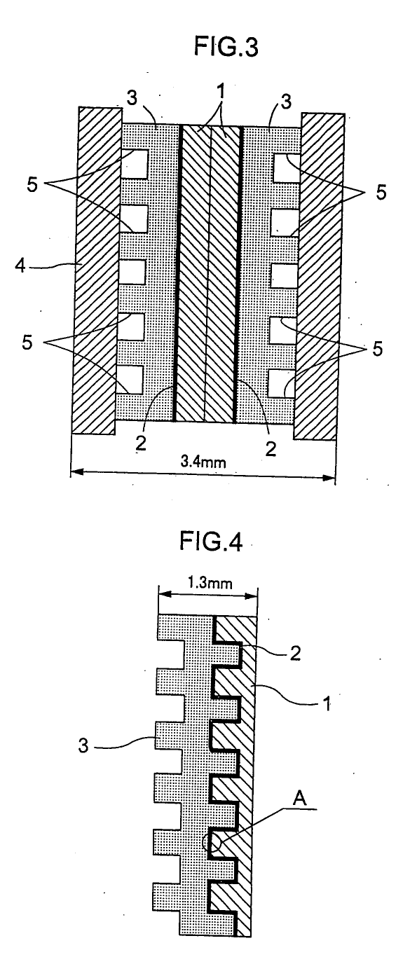

In a polymer electrolyte fuel cell, one cell forming the fuel cell has, as shown in FIG. 3, a pair of electrodes 3 arranged across a solid polymer type electrolyte membrane 1, and joined through catalysts 2 to opposite surfaces of the electrolyte membrane 1. Further, a pair of separators 4 are joined outside the respective electrodes 3.

Oxygen is supplied to grooves 5 formed between one electrode 3 and one separator 4, while hydrogen is supplied to grooves 5 formed between the other electrode 3 and the other separator 4. Thus, the oxygen-side electrode 3 acts as a cathode, and the hydrogen-side electrode 3 as an anode.

In such a polymer electrolyte fuel cell, an electrolyte composite according to the present invention includes the solid polymer type electrolyte membrane 1, and the pair of electrodes 3 joined through the catalysts 2 to the opposite surfaces of the electrolyte membrane 1. The electrodes 3, which are porous and have gas permiability, as shown microscopically enlarged in FIG. 2, include particles 3a of a thermoplastic resin and conductive metal 3b supported in a three-dimensional matrix on the particles 3a.

More particularly, each electrode 3 is manufactured by plating a film of metal 3b on the surfaces of the particles 3a of the thermoplastic resin 0.1 μm to 1,000 μm in diameter, and pressure-welding into a plate form the numerous particles 3a having the metal coating formed thereon. The conductive metal 3b in a matrix form is formed by the metal coating on each particle 3a.

The thermoplastic resin forming each electrode 3 is one selected from the group consisting of polytetrafluoroethylene (PTFE), polyethylene (PE), polypropylene (PP), ABS resin, polyamide (PA), polysulfone (PSU), AS resin, polystyrene (PS), vinylidene chloride resin (PVDC), vinylidene fluoride resin, PFA resin, polyphenylene ether (PFE), methyl pentene resin and methacrylic resin. The conductive metal 3b may be one selected from the group consisting of Ni, Ni alloy, Ni compound, Cu, Cu alloy, Au, Pt, Pt alloy, Pd, Rh and Ru, as described hereinafter.

Next, methods of manufacturing the electrodes electrolyte composite for a fuel cell the according to the present invention will be described with reference to embodiments in which actual manufacture has been carried out.

### EXAMPLE 1

Polytetrafluoroethylene (PTFE) was selected as thermoplastic resin, and a surface adjusting treatment was performed on PTFE particles whose mean particle diameter was 20 μm, by using a fluoric cation surface active agent as surface-treating agent. Specifically, the PTFE particles were agitated in an aqueous solution of 0.75 g/L[C₈F₁₇SO₂NH(CH₂)₃(CH₃)₂N⁺]I⁻ at 70° C. for 10 minutes, and were then thoroughly rinsed. Also usable as the surface-treating agent, besides the fluoric cation surface active agent, are a cation surface active agent other than fluoric, an anion surface active agent and a nonion surface active agent.

After the surface treatment, the surfaces of the PTFE particles were catalytically activated by repeating twice a sensitivity applying treatment with a sensitizer, thorough rinsing, a catalyst applying treatment with an activator, and thorough rinsing. The catalytic activation of the surfaces may be carried out also by repeating a catalyst applying step and an activation step with a dilute acid, for example, besides the method described above.

Next, a metal coating is formed on the surfaces of the PTFE particles by electroless Ni plating. The bath composition and conditions of the Ni plating solution are shown in Table 1 below.

TABLE 1

| | | |
|---|---|---|
| nickel sulfate | 15 | g/L |
| sodium hypophosphite | 14 | g/L |
| sodium hydroxide | 8 | g/L |
| glycine | 20 | g/L |
| pH | 9.5 | |
| bath temperature | 60° | C. |
| agitating time | 40 | min. |

After the electroless Ni plating, electrolytic Ni plating is performed on the PTFE particles, using the plating apparatus disclosed in Patent Application “Kokai” No. 9-106817. The bath composition and conditions of the Ni plating solution are shown in Table 2 below.

TABLE 2

| nickel sulfamate | 350 | g/L |
|---|---|---|
| nickel chloride | 45 | g/L |
| boric acid | 40 | g/L |
| pH | 4.5 | |
| current density | 10 | A/dm² |
| bath temperature | 50° | C. |
| anode | Ni plate | |
| agitating time | 60 | min. |

After the electrolytic Ni plating treatment, the particles were thoroughly rinsed and put to vacuum reduced pressure drying for one hour. The amount of plating was 65.2% by weight, and an average plating film thickness was 0.35 μm.

The Ni plated PTFE particles obtained in this way were pressure-formed, while performing vacuum degassing, in a flat press using a die with one surface shaped rugged, at 300° C. and 100 MPa for five minutes. This produced a plastic body with one surface rugged and the other surface planar, and 40 mm long, 40 mm wide 1 mm thick. This plastic body serves as a parent for an electrode for a fuel cell. An observation of sections of the plastic body has confirmed that it is a porous body having gas permiability.

Further, a 100 μm portion of the planar surface of the plastic body was treated with dilute nitric acid to dissolve the Ni plating film. A platinum (Pt) catalyst was applied to that portion by electrolytic plating method, and then an alcoholic dispersion of Nafion (fluorine solid electrolyte resin with a sulfone group: manufactured by du Pont) used as solid polymer electrolyte membrane was applied and impregnated. The platinum catalyst applied was 8 mg.

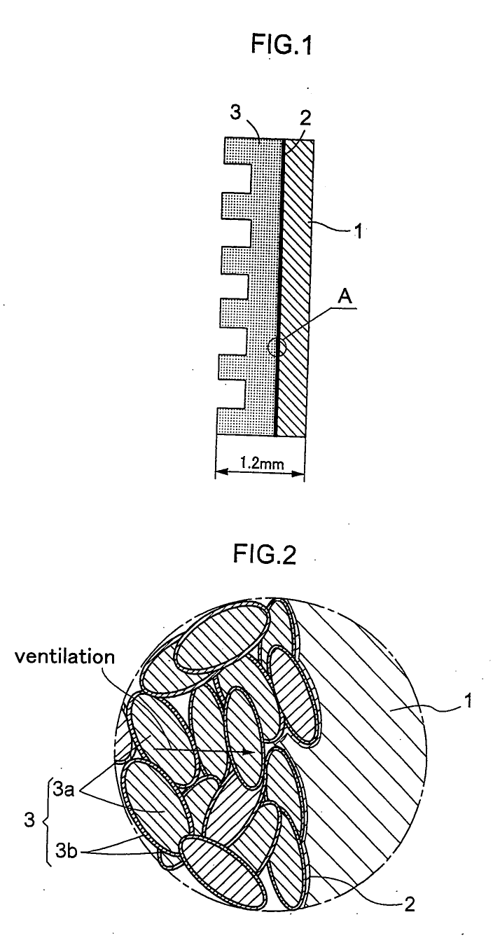

FIGS. 1 and 2 show the composite prepared in this way. In these figures, 1 denotes the fluorine solid electrolyte resin acting as solid polymer electrolyte membrane, 2 denotes the platinum catalyst, 3a denotes the PTFE particles as the thermoplastic resin forming the electrode 3, and 3b denotes the Ni as the metal forming the electrodes 3. The entire product was 1.2 mm thick and was self-sustainable.

A pair of such composites were prepared, one as a cathode and the other as an anode. The surfaces having the electrolyte resin 1 were bonded and joined to each other, and separators 4 formed of carbon with a thickness of 0.5 mm were contact-bonded to the outer surfaces thereof. The product prepared in this way is the single cell of a polymer electrolyte fuel cell shown in FIG. 3.

This single cell is 3.4 mm thick, which is considerably thinner than a conventional single cell whose thickness is 5 mm. Assuming a stack of 400 cells for use on an electric vehicle, for example, a conventional 200 cm stack can now be reduced to about 136 cm.

Further, oxygen in the atmosphere was supplied to the cathode side of this single cell, and hydrogen gas from a commercially available hydrogen gas cylinder to the anode side. An electromotive force was measured in a constant temperature bath at 50° C. to 90° C. As a comparative example, an electromotive force was measured of a single cell of a commercially available polymer electrolyte fuel cell. The electromotive force is a value obtained 2 minutes after start of the gas supply. The results are shown in the following table 3:

TABLE 3

| | 50° C. | 60° C. | 70° C. | 80° C. | 90° C. |
|---|---|---|---|---|---|
| Example | 0.589 V | 0.588 V | 0.580 V | 0.578 V | 0.575 V |
| comparative | 0.579 V | 0.571 V | 0.000 V | 0.000 V | 0.000 V |
| example | | | | | |

As is clear from this table 3, with the electrodes and electrolyte composites for a fuel cell according to the present invention, a voltage of 0.589V can be secured under the 50° C. atmospheric condition, and a voltage close to 0.6V under the 90° C. atmospheric condition.

The electromotive force is greatly influenced by moisture retention of the surface of the anode. When hydrogen ions acting as carriers move from the anode to the cathode, water of hydration also moves together. When moisture is exhausted at the anode side, no further voltage can be obtained.

Therefore, it is highly likely to stop operating under a high temperature condition in which moisture tends to evaporate. With the electrode and electrolyte composite according to the present invention, since one surface of the electrode is etched by treatment with acid, the interface with the electrolyte membrane has an intricate structure. This provides an improved moisture retaining effect, to realize operation at 90° C.

This Fist Example has shown the example of forming Ni film on the surfaces of the particles of the thermoplastic resin as a metal coating. Besides the Ni film, the invention may be implemented by forming a film selected from the group consisting of Ni alloy film, Ni compound film, Cu film, Cu alloy film, Cu compound film, Au film, Pt film, Pt alloy film, Pd film, Rh film and Ru film, or may be one selected from the group consisting of Ni—P, Ni—B, Ni—Cu—P, Ni—Co—P and Ni—Cu—B.

### EXAMPLE 2

Polymethyl methacrylate (PMMA) which is an example of methacrylic resin was selected as thermoplastic resin, and a surface adjusting treatment as in First Example and electroless Ni-PTFE plating were performed on PMMA particles whose mean particle diameter was 10 μm, to form a metal coating on the surfaces of the PMMA particles. The bath composition and conditions of the Ni-PTFE plating solution are shown in Table 4 below.

TABLE 4

| | | |
|---|---|---|
| nickel sulfate | 15 | g/L |
| sodium hypophosphite | 14 | g/L |
| sodium hydroxide | 8 | g/L |
| Glycine | 20 | g/L |
| PTFE (particle diameter: 0.3 μm) | 15 | g/L |
| Surface active agent | 0.5 | g/L |
| Ph | 9.5 | |
| bath temperature | 90° | C. |
| agitating time | 40 | min. |

After the electroless Ni-PTFE plating treatment, the particles were thoroughly rinsed and put to vacuum reduced pressure drying for five hours. The amount of plating was 59.1% by weight, and an average plating film thickness was 0.32 μm.

To the Ni-PTFE plated PMMA particles obtained in this way, calcium carbonate particles 5 μm in average diameter were uniformly mixed in five parts by weight. Then, the particles were pressure-formed, while performing vacuum degassing, in a flat press using a die shaped rugged, at 400° C. and 100 MPa for five minutes. This produced a plastic body with opposite surfaces rugged, and 40 mm long, 40 mm wide and 1 mm thick. An observation of sections of the plastic body, which will serve as a parent for an electrode for a fuel cell, has confirmed that, although presenting fine planes, it becomes a porous body having gas permiability when the plastic body is treated with water containing a dilute acid, to dissolve the calcium carbide.

Further, a platinum catalyst was applied to one surface of the plastic body by electrolytic plating method, and then an alcoholic dispersion of Nafion (fluorine solid electrolyte resin with a sulfone group: manufactured by du Pont) used as solid polymer electrolyte membrane was applied and impregnated. The platinum catalyst applied was 8 mg.

FIG. 4 shows the composite prepared in this way. In the figure, 1 denotes a fluorine solid electrolyte resin acting as solid polymer electrolyte membrane, 2 denotes the platinum catalyst, 3 denotes an electrode. The entire product was 1.3 mm thick and was self-sustainable. This electrode 3 also, when enlarged microscopically, presented a form as shown in FIG. 2, in which the surfaces of the PMMA particles 3a as the thermoplastic resin were coated with Ni acting as the metal 3b.

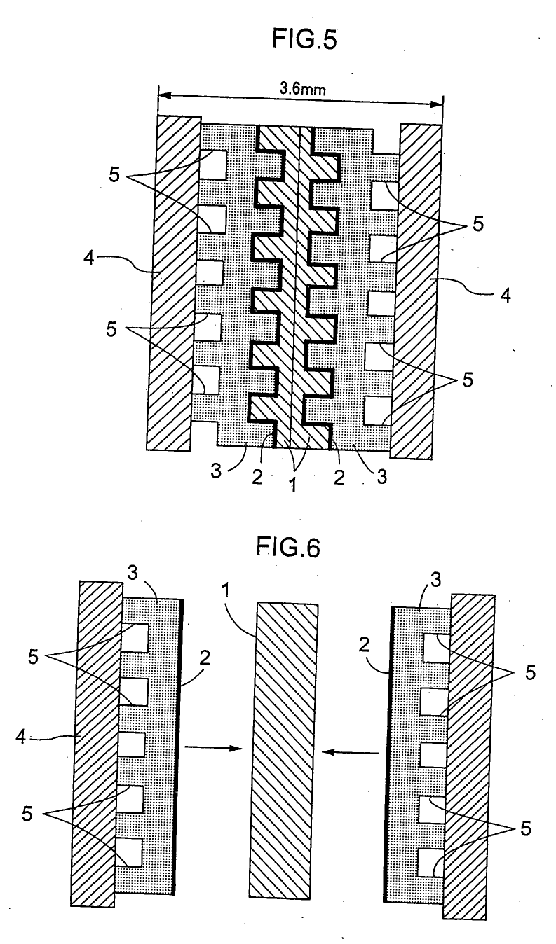

A pair of such composites were prepared, one as a cathode and the other as an anode. The surfaces having the electrolyte resin 1 were bonded and joined to each other, and separators 4 formed of carbon with a thickness of 0.5 mm were contact-bonded to the outer surfaces thereof. The product prepared in this way is the single cell of a polymer electrolyte fuel cell shown in FIG. 5.

This single cell is 3.6 mm thick, which is considerably thinner than a conventional single cell whose thickness is 5 mm. An electromotive force was measured in a constant temperature bath at 50° C. to 90° C. as in First Example. Here again, a voltage close to 0.6V was obtained under the 90° C. atmospheric condition.

This Second Example has shown the example of forming Ni-PTFE film on the surfaces of the particles of the thermoplastic resin as a metal coating, that is the example in which, when forming the metal coating, fine grains of PTFE other than metal were contained in the metal coating. Besides polytetrafluoroethylene (PTFE), the invention may be implemented by containing at least one grain selected from the group consisting of polyethylene (PE), polypropylene (PP), ABS resin, polyamide (PA), polysulfone (PSU), AS resin, polystyrene (PS), vinylidene chloride resin (PVDC), vinylidene fluoride resin, PFA resin, polyphenylene ether (PFE), methyl pentene resin, methacrylic resin, carbon (C), catalyst support grains and thermosetting resin.

First Example and Second Example described above have shown the examples where electrolyte composites for fuel cells are manufactured by joining the electrolyte membranes 1 through catalysts 2 formed on one surface of each of a pair of electrodes 3, and joining together the electrolyte membranes of the two electrodes 3. As shown in FIG. 6, they may be manufactured by joining a pair of electrodes 3 through catalysts 2 to opposite surfaces of an electrolyte membrane 1.

The separators 4 may be joined to the electrodes 3 either before or after joining the electrodes 3 to the electrolyte membrane 1.

### INDUSTRIAL UTILITY

The invention provides electrodes and electrolyte composites for fuel cells for achieving a cost reduction and thickness reduction of the fuel cells, and manufacturing methods for the electrodes and electrolyte composites for fuel cells.

1. An electrode for a fuel cell comprising a porous thermoplastic resin having gas permiability, and a metal supported in a three-dimensional matrix form on the thermoplastic resin.

2. An electrode for a fuel cell as defined in claim 1, wherein said thermoplastic resin is at least one selected from the group consisting of polytetrafluoroethylene (PTFE), polyethylene (PE), polypropylene (PP), ABS resin, polyamide (PA), polysulfone (PSU), AS resin, polystyrene (PS), vinylidene chloride resin (PVDC), vinylidene fluoride resin, PFA resin, polyphenylene ether (PFE), methyl pentene resin and methacrylic resin.

3. An electrolyte composite for a fuel cell having a solid polymer type electrolyte membrane, and a pair of electrodes joined through catalysts to opposite surfaces of the electrolyte membrane,
wherein each of said pair of electrodes comprises a porous thermoplastic resin having gas permiability, and a metal supported in a three-dimensional matrix form on the thermoplastic resin.

4. A method of manufacturing an electrode for a fuel cell comprising plating a metal coating on surfaces of numerous particles of a thermoplastic resin, and pressurizing and pressure-welding into a plate form the numerous particles having the metal coating formed thereon.

5. A method of manufacturing an electrode for a fuel cell as defined in claim 4, wherein said particles are 0.1 m to 1,000 m in diameter.

6. A method of manufacturing an electrode for a fuel cell as defined in claim 4, wherein said metal coating is one selected from the group consisting of Ni film, Ni alloy film, Ni compound film, Cu film, Cu alloy film, Cu compound film, Au film, Pt film, Pt alloy film, Pd film, Rh film and Ru film.

7. A method of manufacturing an electrode for a fuel cell as defined in claim 4, wherein said metal coating is a film selected from the group consisting of Ni—P, Ni—B, Ni—Cu—P, Ni—Co—P and Ni—Cu—B.

8. A method of manufacturing an electrode for a fuel cell as defined in claim 4, wherein, when forming said metal coating, fine grains other than metal are contained in said metal coating, said fine grains being at least one selected from the group consisting of polytetrafluoroethylene (PTFE), polyethylene (PE), polypropylene (PP), ABS resin, polyamide (PA), polysulfone (PSU), AS resin, polystyrene (PS), vinylidene chloride resin (PVDC), vinylidene fluoride resin, PFA resin, polyphenylene ether (PFE), methyl pentene resin, methacrylic resin, carbon (C), catalyst support grains and thermosetting resin.

9. A method of manufacturing an electrolyte composite for a fuel cell having a solid polymer type electrolyte membrane, and a pair of electrodes joined through catalysts to opposite surfaces of the electrolyte membrane, said method of manufacturing an electrolyte composite for a fuel cell comprising:
manufacturing said pair of electrodes by plating a metal coating on surfaces of numerous particles of a thermoplastic resin, and pressurizing and pressure-welding into a plate form the numerous particles having the metal coating formed thereon; and
joining said electrolyte membrane through said catalyst to one surface of each of the pair of electrodes, and joining said electrolyte membranes of the two electrodes.

10. A method of manufacturing an electrolyte composite for a fuel cell having a solid polymer type electrolyte membrane, and a pair of electrodes joined through catalysts to opposite surfaces of the electrolyte membrane, said method of manufacturing an electrolyte composite for a fuel cell comprising:
manufacturing said pair of electrodes by plating a metal coating on surfaces of numerous particles of a thermoplastic resin, and pressurizing and pressure-welding into a plate form the numerous particles having the metal coating formed thereon; and
joining the pair of electrodes through said catalysts to the opposite surfaces of said electrolyte membrane.

11. A method of manufacturing an electrode for a fuel cell as defined in claim 5, wherein said metal coating is one selected from the group consisting of Ni film, Ni alloy film, Ni compound film, Cu film, Cu alloy film, Cu compound film, Au film, Pt film, Pt alloy film, Pd film, Rh film and Ru film.

12. A method of manufacturing an electrode for a fuel cell as defined in claim 5, wherein said metal coating is a film selected from the group consisting of Ni—P, Ni—B, Ni—Cu—P, Ni—Co—P and Ni—Cu—B.

13. A method of manufacturing an electrode for a fuel cell as defined in claim 5, wherein, when forming said metal coating, fine grains other than metal are contained in said metal coating, said fine grains being at least one selected from the group consisting of polytetrafluoroethylene (PTFE), polyethylene (PE), polypropylene (PP), ABS resin, polyamide (PA), polysulfone (PSU), AS resin, polystyrene (PS), vinylidene chloride resin (PVDC), vinylidene fluoride resin, PFA resin, polyphenylene ether (PFE), methyl pentene resin, methacrylic resin, carbon (C), catalyst support grains and thermosetting resin.
